(19) United States
(12) Patent Application Publication
(10) Pub. No.: US 2014/0372507 A1
(43) Pub. Date: Dec. 18, 2014

(54) Reporting Exceptions from Executing Compressed Scripts

(71) Applicant: Microsoft Corporation, Redmond, WA (US)

(72) Inventors: Russell Ray Rutledge, Redmond, WA (US); Harry Phillip Ferguson, IV, Redmond, WA (US); Ronald K. Logan, Duvall, WA (US)

(21) Appl. No.: 13/917,980

(22) Filed: Jun. 14, 2013

(51) Int. Cl. H04L 29/08

(52) U.S. Cl. CPC H04L 67/06
USPC 709/203

(57) ABSTRACT

An original script program includes code that configures an application to gather error information when a script error occurs, and to transmit this error information to a server computer. Thus, if the script causes an exception to be thrown when processed by the application, data describing the exception is sent to the server computer. The exception data is accessed by a diagnostic tool to identify the error in the original script program. Such data can be collected from multiple applications on multiple client computers after a resource with a compressed script program is made available on a server computer. Using a mapping between tokens in the compressed script program and the original script program, the diagnostic tool relates each error in the compressed script to locations within the original script program.

### BACKGROUND

A browser application is a computer program that is designed to run on a client computer to allow the client computer to access resources located on server computers, to which the client computer connects over a computer network. A popular and common use of a browser application is to allow individuals to connect to such server computers over the internet to access “web pages” and other resources. Such a browser application communicates with server applications on the server computer using various protocols, such as the hypertext transfer protocol (HTTP) and other protocols that work over the transfer control protocol/internet protocol (TCP/IP).

The resources available through a web server can be or can include computer programs. Such computer programs commonly are written first as a source computer program, typically using a scripting programming language, such as the JavaScript language, or other similar computer programming language. The source computer program, or original script, is then processed, such as by being compiled or compressed. For example, a script in the JavaScript language can be compressed using a “minifier” tool, of which there are several. The compressed source computer program, or compressed script, is made available on the server for access by browser applications.

Such scripting programs can be used in a variety of other settings and are not limited to use in browser applications. In general, a platform, i.e., a combination of computer hardware and operating system, receives a script program and runs an application with an interpreter to process the script.

If there is an error in an original script, then the compressed script also will have errors. If there an error occurs when a browser application, or other platform with a script interpreter, processes the script, the interpreter will throw an exception. Generally the script interpreter, or other application using it, presents a message to a user on the computer executing the browser application that the script error occurred. A developer typically uses a local browser application or other interpreter to test compressed scripts, which allow the developer to identify and fix errors, and then deploy the computer program.

### SUMMARY

This Summary introduces selected concepts in simplified form that are further described below in the Detailed Description. This Summary is intended neither to identify key or essential features of the claimed subject matter, nor to limit the scope of the claimed subject matter.

When a script is deployed for use by a large number of users, such as being made available on a server computer, the developer does not have access to the browser application or other script interpreter to determine if errors occur when the script is processed. Further, it can be challenging to map error messages from a variety of different browser applications and script interpreters using a compressed script program to identify the origin of the error in the original script program.

To address these problems, an original script program includes code that configures a script interpreter, such as in a browser application, to gather error information when a script error occurs, and transmits this error information to a server computer. Thus, if an exception is thrown when processing the script, data describing the exception is sent to a server, from which it can be accessed by a diagnostic tool to assist in identifying the error in the original script program. Such data can be collected from multiple browser applications, or other platforms with a script interpreter, after a resource with a compressed script program is made available on a server computer.

When source code for the original script program in a scripting language is compressed, a mapping is created between points in the compressed script program and the original script program. The mapping identifies where various tokens, such as function calls, variable names and file names, occur in both the original script program and the compressed script program. Thus, given the error information from browser applications when an error occurs processing the compressed script program, each error can be related to points within the original script program given a location of the error in the compressed script program.

The diagnostic tool can include, for example, a computer program executing on the server computer that collects exception data from browser applications. The diagnostic tool also can include a computer program that analyzes exception data, original script program, compressed script program, and associated mapping files, to identify where the error is in the original script file.

The mapping files can include a file map that contains information that allows a source file to be identified if multiple source files are used to define the original script program. In addition, the mapping files can include a context map that contains information that allows variable names from different scopes in the compressed script to be mapped to names of their correct scopes in the original source script.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example system in which exceptions from compressed scripts are processed.

FIG. 2 is a data flow diagram illustrating an example implementation of a diagnostic tool.

FIG. 3 is a flow chart describing an example implementation of identifying a location of an error in an original source file given exception data from a browser application executing a compressed script.

FIG. 4 is a block diagram of an example computer with which components of such a system can be implemented.

### DETAILED DESCRIPTION

The following section provides an example computer system in which exceptions from executing compressed scripts, such as in browser applications on client computers, can be processed at a server.

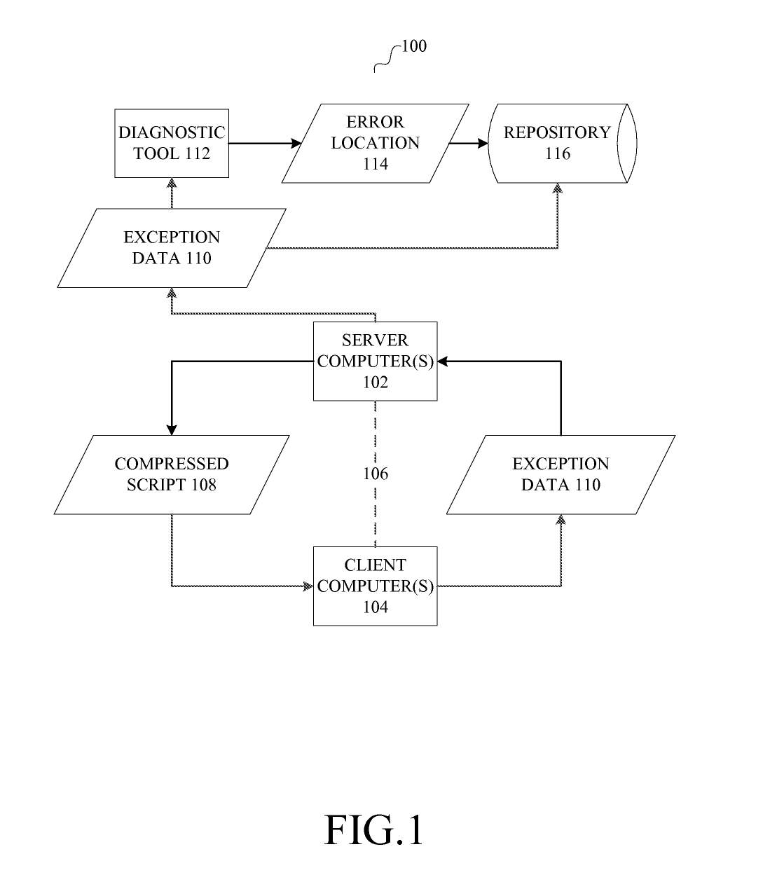

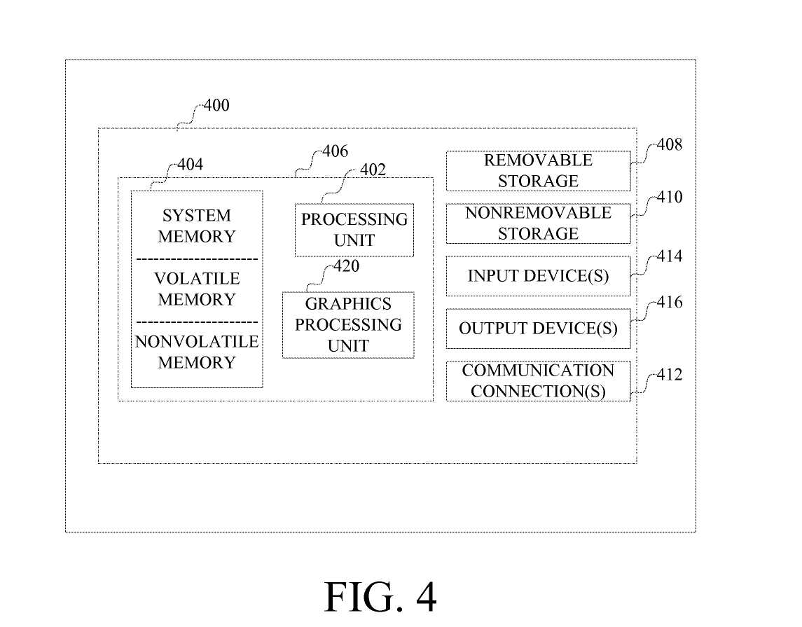

Referring to FIG. 1, a computer system 100 includes one or more server computers 102 and one or more client computers 104 interconnected by a computer network 106. Both the client computer(s) and the server computer(s) can be implemented using a computer such as described below in connection with FIG. 4. In an example implementation, the server computer is programmed with a server application; the client computer is programmed with a browser application or other application including a script interpreter. The server computer is programmed to respond to requests from the client computer for resources residing on the server computer. As an example, the server computer can include scripts, i.e., computer programs written in a scripting language, that are processed by applications, such as a browser application, on the client computer. Such a script can be a compressed script 108 embedded in a resource, such as a web page in the hypertext markup language (HTML) or the like, which is accessed by a web browser through a web server using the hypertext transfer protocol (HTTP) or the like over a computer network.

When processed by an application, an error in a compressed script program 108 can cause the application, such as a browser application, to throw an exception. Information about the exception can be communicated to a user, stored, or the like. To permit a diagnostic tool to help a developer to modify the script, the script includes an instruction to the client computer to capture data 110 about exceptions, and send this data to a server computer. In FIG. 1, the server computer receiving the exception data 110 is illustrated as the same server computer that provides the script 108; it should be understood that another server computer can be used to receive such exception data.

A diagnostic tool 112, a computer program executed on a computer, gathers exception data 110, indicating one or more scripts and one or more locations of errors in the compressed scripts, and provides an indication 114 of a location for each error in original script programs, and optionally additional information such as text from the original script program that relates to the error. The diagnostic tool can reside on one of the server computers 102, or on one or more different computers, or both. In an example implementation, the diagnostic tool resides partly on the server computer, to gather exception data 110 from multiple browser applications for multiple scripts; the diagnostic tool resides partly on another computer to analyze the exception data.

The various exception data 110 and indications 114 of the locations of those errors in the original scripts can be communicated to developers and/or stored on a computer storage medium, such as in a repository 116 which can be implemented using a database executed on one or more computers (such as in FIG. 4) using computer storage media to store the data. Such a repository can include various information related to the exception data 110, including but not limited to, date and time the error occurred, other information from the client computer, path and file names of the source and compressed scripts and the like. Such a repository can be used for various analyses and searching.

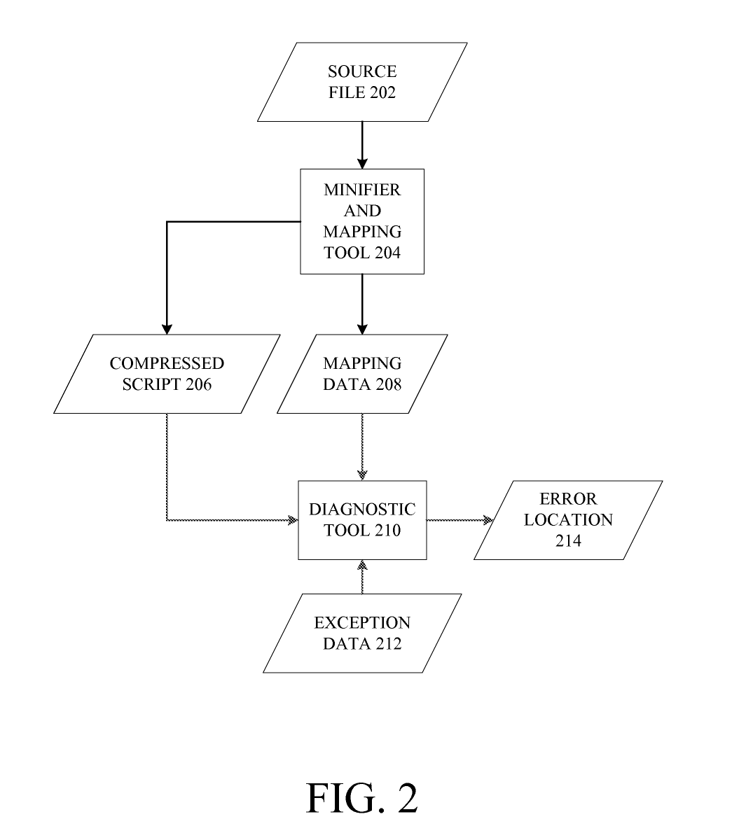

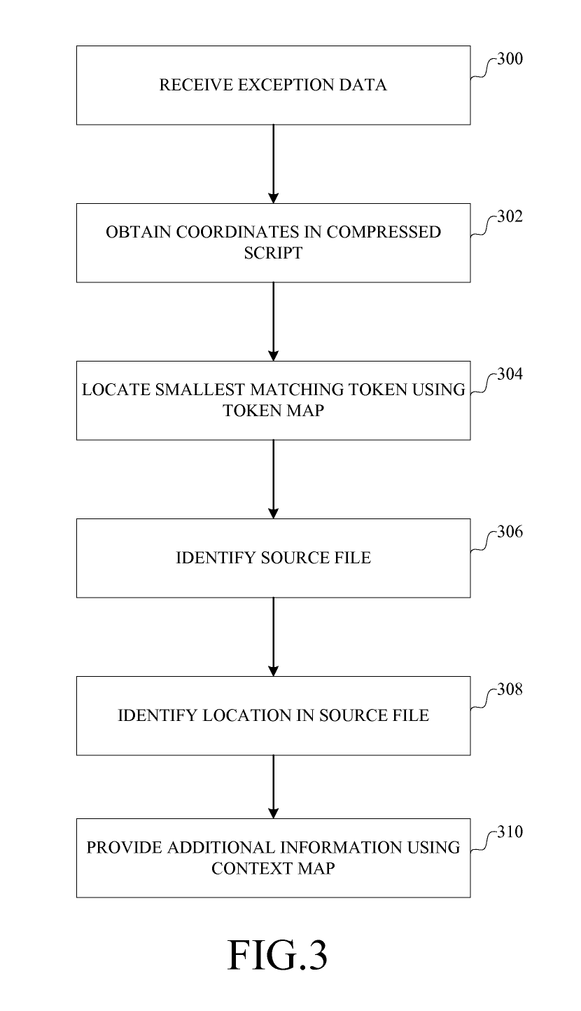

Given this context, an example implementation of the diagnostic tool will be described in more detail in connection with FIGS. 2-3.

FIG. 2 is a data flow diagram of an example implementation of a diagnostic tool, including other tools that provide context for the inputs to the diagnostic tool. An original source file 202 for a script is input to a minifier and mapping tool 204 which outputs the compressed script 206 and mapping data 208. The minifier and mapping tool can include one or more computer programs, i.e., applications, which provide the compressed script 206 and mapping data 208. For example, one application can provide the compressed script 206 and a token map, whereas other applications can provide file maps and context maps. A diagnostic tool 210 receives the mapping data 208 and exception data 212, to generate an indication 214 of the location of the error in the source file 202.

How the indication 214 of the location of the error in the source file 202 is determined from the exception data 212 depends in part on the exception data 212 and the mapping data 208.

In some cases, exception data 212 includes a line number of the script in which there is a token, that when processed generated the exception, and a position of the particular token in that line. With compressed scripts, the script is generally only one line. The position of the token is generally provides as a character count position from the beginning of the compressed script. In some cases, the exception data 212 includes a text extract, indicating the token or tokens that, when processed, generated the exception.

The exception data 212 is returned to the server computer by embedding, in the original script program, and thus the compressed script, instructions to gather exception data and send the exception data to the server computer. Such instructions are dependent on the platform and interpreter, such as the browser application. Thus the instructions also can include a switch depending on the browser application or other interpreter detected by the script program.

Example script instructions in one implementation are below:

window.onerror = function(message, jsUrl, jsLine)
{

// Send the message, jsUrl, and arguments.callee.caller to remote
server for logging.
// * jsUrl is the path to the script file that contains the code that threw
the exception.
// * arguments.callee.caller is the full text of the function definition

that contains the code that threw the exception.

// * jsLine is the line number in the script file at which the exception
occurred.

};
try
{

// Execute product code.

}
catch (e)
{

if (e.stack)
{

// Send data in e.stack to remote server for logging.

}
else
{

// Re-throw exception to reconstruct stack information at the
global onerror handler.
throw e;

}

}

In the foregoing example, for some platforms the “try” and “catch” instructions implement the exception data gathering steps. After an exception occurs in the executed product code, exception data may reside in the processing stack (e.stack). If the exception data is in the stack, then code can be executed that ends the data to a remote server for logging. If the exception data is not present in the stack, the exception can be re-thrown (“throw e;”) to reconstruct the stack information for a global “onerror” handler.

Some other browser applications provide text in the exception messages, such as the function definition that contains code that threw the exception, along with the line number and script file name, relating to the error. This information can be provided in the stack. Note that in a compressed script, the line number is generally “1” and not helpful. The “window.onerror”, or other globally defined error handler, sends the exception data from the reconstructed stack along with the specified parameters to the server computer.

After the server computer receives exception data 212 from one or more client computers, the exception data can be processed by the diagnostic tool 210 to locate the error in the source script. To perform this processing, the diagnostic tool uses mapping data 208 in a manner described in more detail below in connection with FIG. 3.

The mapping data includes a token map that maps positions of tokens in the compressed script to positions of tokens in the source file. In one example implementation, for each token identified in the source file, this token map includes several values: the start line, start column, end line and end column of the token in the destination, i.e., the compressed script; the start position, end position, start line, start column, end line, end column in the source file, i.e., the source script, a source file identifier, a token type, and any parent function that defines scope for which the token in the compressed script is valid. Such token maps can be called source maps and are commonly generated by minifier tools for JavaScript programs.

The mapping data also can include a file map. A file map is used if the original script program is defined by multiple files and if the token map does not distinguish tokens from different files (for example, if the token map is generated for one source file generated by concatenating all of the original source files). An example file map includes data defining the files used, such as by path and file name as accessed by the diagnostic tool, the order of the files, and the size, such as line counts or total number of characters or file size, for each of the referenced source files. The line counts or total number of characters allow a position in an original concatenated source file used to generate the token map to be mapped to a corresponding position in an original source file.

The mapping data also can include a context map. A context map is used to augment the information provided by the token map. In particular, as noted above, the token map generally includes mappings between a range of code in the original script and a range of code in the compressed script, a type of token or set of tokens that defines that scope with in the code, and any type or name of any parent object that contains the token or set of tokens. The information automatically generated by many minifier tools does not include any mapping of the contextual information, such as mapping source and destination tokens for function names, variable names and the like, or a name or label for a token. To the extent such information is not available, a context map can be created by analyzing the original source file and generating the map.

In one implementation a context map includes, for each scope defined in the original source file (i.e., each function, etc.), the line and column at which the scope begins and a label or name for the scope from the original script. Given the type of the scope, such as a function declaration, additional data related to the scope is defined. For example, for a function declaration, a list of each argument is provided, followed by a list of variable definitions. The context map includes, for each argument or variable definition or other token, its source line and column, its name in the source script, its name in the compressed script and its type.

Such mapping data can be defined using one or more markup language files. For example, a markup element can define a header that sets forth the mapping values such as described above.

In the token map, multiple markup elements can be provided to represent each token found in the original source file and its mapping to a token in the compressed script.

In a file map, a markup element can be provided for each file, in the order files are concatenated, identifying the filename and path of the source file and its total number of lines, total number of characters or other size information.

In a context map, a markup element can be provided for each scope. Named tokens within that scope are defined as markup elements contained within the markup element for the scope. For example, within an element for a function, additional elements are defined for each argument, variable definition and the like, within the function. Attributes of each of these elements include, for example, its line and column in the original source file, and label or names used in both the source file and the compressed script.

An example implementation of a process for recovering a location in an original script file from exception information will now be described in connection with FIG. 3. In FIG. 3, exception data is received 300. Coordinates in the compressed script of the token causing the error are obtained 302. For example, the exception data can include one or more indications of such coordinates, in the form of a column number in the line of the compressed script. As another example, if the exception data is text from the compressed script, then a position can be obtained by doing a string match between the text from the exception and the text of the compressed script.

Using the token map, the position in the compressed script is used to identify 304 the smallest token that contains the position of the error. For example, using the token map, the position of the error is compared to the destination range (e.g., start column and end column) of each token to determine if that token contains the position of the error. However, in the token map, there can be many tokens that contain the specified position. Thus, the smallest token is used.

Given the identified smallest token containing the error, its corresponding source file is identified 306. For example, the token map can specify the source file identifier for each token. In the event there is only one source file used to generate the token map, which was generated from multiple files, a file map can be used to identify the source file. For example, given the token, its source position can be retrieved from the token map. Using the file map, the source position can be mapped to one of the files used to generate the source file.

Given the identity of the source file, the location in the source file of the token corresponding to the error is thus determined 308. For example, the file map information can be used to translate a position of a concatenated source file used to generate the token map into a position in the identified source file.

Using the context map for the original source script, additional information about the error can be provided 310. For example, if the token map does not provide information about the labels in the original source file, then the context map can be used to provide that information. The identity of the source file is used to access its context map. The location within that source file is used to identify a scope using the context map. Within the identified scope, additional information can be accessed, such as a particular argument or variable defined within that scope. For example, if the exception data indicated an error that a variable “n” was undefined, given the scope of in the original source file, the variable “n” can be identified, and its corresponding name in the original source file can be retrieved and presented to the developer.

After processing the exception data for an error, a variety of information about the error then can be, for example, stored in a database, or stored in a development environment, or communicated to a developer, and the like.

Having now described an example implementation, a computer with which components of such a system are designed to operate will now be described. The following description is intended to provide a brief, general description of a suitable computer with which such a system can be implemented. The computer can be any of a variety of general purpose or special purpose computing hardware configurations. Examples of well-known computers that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

FIG. 4 illustrates an example of a suitable computer. This is only one example of a suitable computer and is not intended to suggest any limitation as to the scope of use or functionality of such a computer.

With reference to FIG. 4, an example computer 400, in a basic configuration, includes at least one processing unit 402 and memory 404. The computer may include multiple processing units and/or additional co-processing units such as graphics processing unit 420. Depending on the exact configuration and type of computer, memory 404 may be volatile (such as RAM), non-volatile (such as ROM, flash memory, etc.) or some combination of the two. This configuration is illustrated in FIG. 4 by dashed line 406.

Additionally, computer 400 may also have additional features/functionality. For example, computer 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer program instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computer 400. Any such computer storage media may be part of computer 400.

Computer 400 may also contain communications connection(s) 412 that allow the device to communicate with other devices over a communication medium. Communication media typically carry computer program instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 412 are devices that interface with the communication media to transmit data over and receive data from communication media, such as a network interface.

Computer 400 may have various input device(s) 414 such as a keyboard, mouse, pen, camera, touch input device, and so on. Output device(s) 416 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

Each component of this system that operates on a computer generally is implemented by software, such as one or more computer programs, which include computer-executable instructions and/or computer-interpreted instructions, such as program modules, being processed by the computer. Generally, program modules include routines, programs, objects, components, data structures, and so on, that, when processed by a processing unit, instruct the processing unit to perform particular tasks or implement particular abstract data types. This computer system may be practiced in distributed computing environments where tasks are performed by remote processing devices that are linked through a communications network. In a distributed computing environment, program modules may be located in both local and remote computer storage media including memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process performed by a processor in a computer, comprising:
providing compressed script programs on a server computer in a manner accessible by applications executed on client computers that connect to the server computer over a computer network, the compressed script programs including computer program instructions configuring the application to gather and transmit exception data to a server computer;
receiving the exception data from the applications; and
processing the exception data to determine a location in an original script program corresponding to the exception data.

2. The computer-implemented process of claim 1, wherein processing the exception data comprises accessing a token map that maps positions in the compressed script program to positions in an original script program.

3. The computer-implemented process of claim 2, wherein processing the exception data comprises accessing a file map that maps files to positions in an original script program.

4. The computer-implemented process of claim 1, wherein processing the exception data comprises accessing a context map to identify labels in the original script program using location in the original script program corresponding to the exception data.

5. The computer-implemented process of claim 2, wherein the token map includes, for each token in an original script program, an indication of a start position and end position of the token in the compressed script program.

6. The computer-implemented process of claim 5, wherein processing the exception data comprises:
identifying a position of a token in the compressed script program corresponding to the exception data.

7. The computer-implemented process of claim 6, wherein processing the exception data comprises:
identifying, using the token map, a smallest token containing the position of the token in the compressed script program corresponding to the exception data.

8. An article of manufacture comprising:
a computer storage medium;
computer program instructions stored on the computer storage medium which, when processed by a processing device, instruct the processing device to perform a process comprising:
providing compressed script programs on a server computer in a manner accessible by applications executed on client computers that connect to the server computer over a computer network, the compressed script programs including computer program instructions configuring the application to gather and transmit exception data to a server computer;
receiving the exception data from the applications;
processing the exception data to determine a location in an original script program corresponding to the exception data.

9. The article of manufacture of claim 8, wherein processing the exception data comprises accessing a token map that maps positions in the compressed script program to positions in an original script program.

10. The article of manufacture of claim 9, wherein processing the exception data comprises accessing a file map that maps files to positions in an original script program.

11. The article of manufacture of claim 9, wherein the token map includes, for each token in an original script program, an indication of a start position and end position of the token in the compressed script program.

12. The article of manufacture of claim 11, wherein processing the exception data comprises:
identifying a position of a token in the compressed script program corresponding to the exception data.

13. The article of manufacture of claim 12, wherein processing the exception data comprises:
identifying, using the token map, a smallest token containing the position of the token in the compressed script program corresponding to the exception data.

14. A computer system comprising one or more server computers providing compressed script programs in a manner accessible by applications executed on client computers that connect to the server computer over a computer network, the compressed script programs including computer program instructions configuring the application to gather and transmit exception data to the one or more server computers, the one or more server computers being configured to:
receive the exception data from the applications;
process the exception data to determine a location in an original script program corresponding to the exception data.

15. The computer system of claim 14, wherein the one or more server computers are configured to process the exception data by accessing a token map that maps positions in the compressed script program to positions in an original script program.

16. The computer system of claim 15, wherein the one or more server computers are configured to process the exception data by accessing a file map that maps files to positions in an original script program.

17. The computer system of claim 14, wherein the one or more server computers are configured to process the exception data by accessing a context map to identify labels in the original script program using location in the original script program corresponding to the exception data.

18. The computer system of claim 15, wherein the token map includes, for each token in an original script program, an indication of a start position and end position of the token in the compressed script program.

19. The computer system of claim 18, wherein the one or more server computers are configured to process the exception data by identifying a position of a token in the compressed script program corresponding to the exception data.

20. The computer system of claim 19, wherein the one or more server computers are configured to process the exception data by identifying, using the token map, a smallest token containing the position of the token in the compressed script program corresponding to the exception data.
